(19) United States
(12) Patent Application Publication
(10) Pub. No.: US 2024/0303588 A1
(43) Pub. Date: Sep. 12, 2024

(54) LOGISTICS QUOTATION SYSTEM APPLIED TO OPERTION END AND METHOD FOR OPERTING THE SAME

(71) Applicants: Zhen-sheng Wang, Santa Fe Springs, CA (US); Ze-Nong Wang, Santa Fe Springs, CA (US); Ze-Feng Wang, Santa Fe Springs, CA (US)

(72) Inventors: Zhen-sheng Wang, Santa Fe Springs, CA (US); Ze-Nong Wang, Santa Fe Springs, CA (US); Ze-Feng Wang, Santa Fe Springs, CA (US)

(21) Appl. No.: 18/118,678

(22) Filed: Mar. 7, 2023

(51) Int. Cl. G06Q 10/0834

(52) U.S. Cl. CPC G06Q 10/08345

(57) ABSTRACT

A logistics quotation system applied to operation end and a method for operating the same, wherein the system includes a work order module, a transportation matching module, a calculation module and a quotation module. The work order module includes an order receiving section and a writing section. The transportation matching module is connected to a transportation database and includes a reading section and a matching section. The calculation module includes a calculation section. The quotation module is connected to the customer end. By operation of each of the modules, the information of the customers is processed by computers and automatically calculated to obtain the required operation amounts which are sent to the customer end. Compared with the previous technology, the system greatly reduces the possibility of manual errors and the cost of intermediate procedures, and also simplifies steps for the consumers and operators.

### BACKGROUND OF THE INVENTION

### 1. Fields of the Invention

The present invention relates to a field of shopping logistics, and more particularly, to a logistics quotation system and operation method applied to operation end.

### 2. Descriptions of Related Art

As technology continues to grow and evolve, with the continuous popularization of the internet, people purchase products or goods through the internet have gradually increased. At the same time, due to the globalization brought about by the internet, people can buy goods from different regions and countries. In order to reach the destination, the purchase of goods from distant places must rely on the help of various logistics. Therefore, the dependence on transportation logistics is also gradually increasing, making the establishment of a successful and stable logistics system an important issue for modern society.

There are many procedures required when purchasing goods from different regions and countries, including the source of the shopping, crossing customs, whether the goods conform to the local laws and regulations, and the method used for transportation operations. Many procedures and costs incurred will affect whether consumers will purchase specific goods. Therefore, it is very important to inform consumers in advance of the cost of shopping and logistics.

However, in modern times, most transportation logistics operations still use manual calculations for inquiries and quotations, such as using paper, telephone, mailbox, text messages, etc. to communicate with customers and consignors. After inquiring about prices and processes from consignors and transporters, manually calculate the price and then inform the quotation to the customers through the same method. If the customers have any other inquiries or changes the shopping goods, the operation end still needs to re-inquire from the consignor and transporter and recalculate the amount. Thereby causing a lot of time loss and trouble. At the same time, manual calculations may result in errors, leading to incorrect quotation.

Therefore, if we can optimize and improve the above problems, we can effectively reduce the time loss and trouble of remote shopping and enhance customers' trust and desire for remote shopping.

The present invention intends to provide a logistics quotation system and operation method applied to operation end to eliminate the shortcomings mentioned above.

### SUMMARY OF THE INVENTION

The present invention relates to a logistics quotation system applied to operation end, and the logistics quotation system comprises a work order module, a work order module, a transportation matching module, a calculation module, and a quotation module connected with each other. The work order module is connected to a customer end and includes an order receiving section and a writing section which is connected to the order receiving section. The order receiving second receives an inquiry information from the customer end and sends the inquiry information to the writing second. The writing section creates the inquiry information into a work order form.

The transportation matching module is connected with a transportation database. The transportation matching module includes a reading section and a matching section which is connected to reading section. The reading section reads an information from the transportation database and the work order form, and the matching section matches multiple transportation modes that match the work order form.

The calculation module includes a calculation section which calculates an operation amount required by each of the multiple transportation modes that match the work order form.

The quotation module is connected with the customer end, and receives and integrates the operation amount from the calculation module, and sends a quotation information to the customer end.

The present invention also provides a method for operating logistics quotation system applied to operation end. The method comprises an order receiving step, a transportation matching step, a calculation step and a quotation step.

The order receiving step is that after a customer end has input the inquiry information, a work order module receives the inquiry information and creates a work order form.

The transportation matching step is that after the order receiving step is completed, the work order form is sent to a transportation matching module. The transportation matching module is connected to a transportation database. The transportation matching module matches multiple transportation modes with the work order form. The multiple transportation modes are sent to the calculation module.

The calculation step is that after the transportation matching step is completed, the calculation module calculates an operation amount required by each of the multiple transportation modes that match the work order form.

The quotation step is that after the calculation step is completed, a quotation module receives and integrates the operation amounts from the calculation module, and sends a quotation information to the customer end.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the components of the logistics quotation system applied to operation end of the present invention;

FIG. 2 shows the flow chart of operation of the logistics quotation system applied to operation end of the present invention, and

FIG. 3 shows the steps of the method for operating the logistics quotation system applied to operation end.

### DETAILED DESCRIPTION OF THE PREFERRED EMBODIMENT

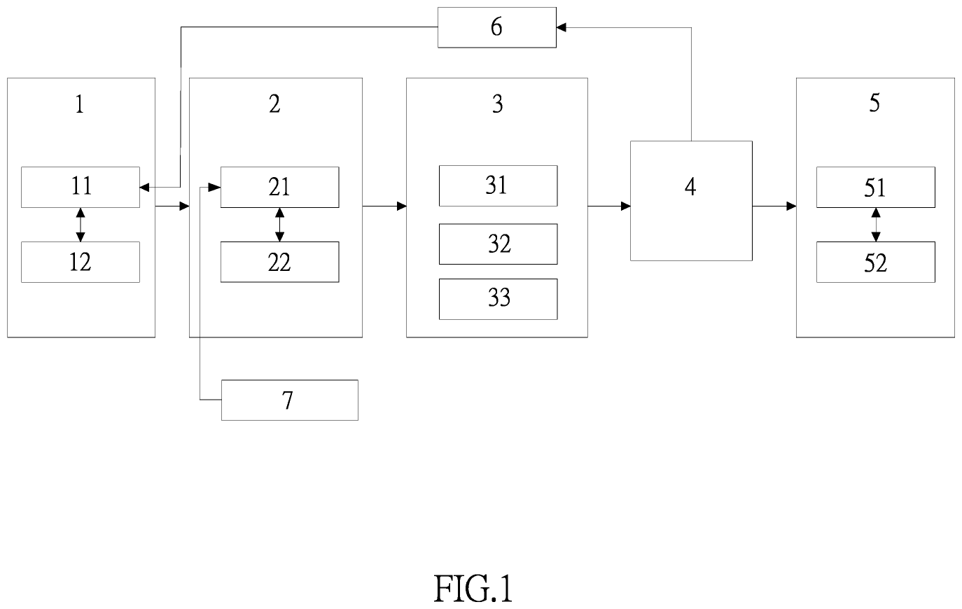

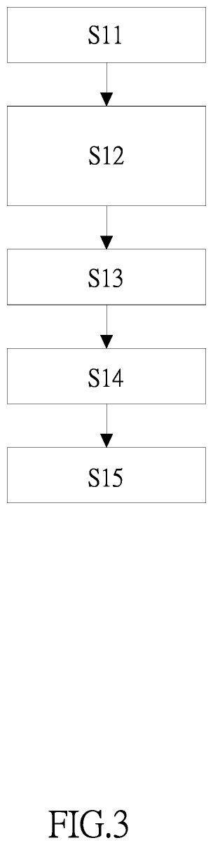

Referring to FIGS. 1 and 2, the logistics quotation system applied to operation end of the present invention comprises a work order module 1, a transportation matching module 2, a calculation module 3 and a quotation module 4. The work order module 1 is connected to a customer end 6 and includes an order receiving section 11 and a writing section 12 which is connected to the order receiving section 11. The order receiving second 11 receives an inquiry information from the customer end 6 and sends the inquiry information to the writing second 12. The writing section 12 creates the inquiry information into a work order form. The work order module 1 sends the work order form to the transportation matching module 2.

The transportation matching module 2 is connected with a transportation database 7. The transportation matching module 2 includes a reading section 21 and a matching section 22 which is connected to reading section 21. The reading section 21 reads an information from the transportation database 7 and the work order form, and the matching section 22 matches multiple transportation modes that match the work order form. The multiple transportation modes are then sent to the calculation module 3.

The calculation module 3 includes a calculation section 31 which calculates an operation amount required by each of the multiple transportation modes that match the work order form. The operation amount is then sent to the quotation module 4.

The quotation module 4 is connected with the customer end 6. The quotation module 4 receives and integrates the operation amount from the calculation module 3 and sends a quotation information to the customer end.

In addition, the calculation module 3 further includes a time estimating section 32 which calculates an estimated processing time of each of the multiple transportation modes.

The calculation module 3 further includes a price comparison section 33. The price comparison section 33 compares operation amounts and estimates processing times matched with the multiple transportation modes. The price comparison section 33 calculates and provides multiple options in sequence that meets needs of the customer end 6.

The logistics quotation system further comprises a recording module 5. The recording module 5 includes a track section 51 and a storage section 52 connected to the track section 51. The track section 51 records operation information of data input, modification and change of the customer end 6 before and after the quotation information is sent. The storage section stores the operation information recorded by the track section 51.

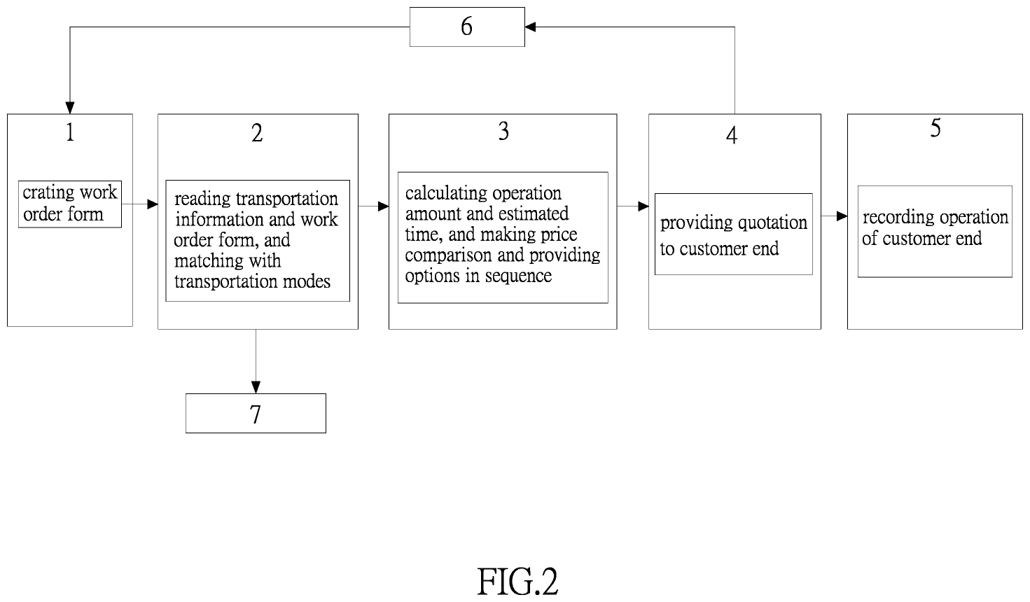

As shown in FIGS. 1 to 3, the present invention also provides a method for operating logistics quotation system applied to operation end, and the method comprises an order receiving step S11, a transportation matching step S12, a calculation step S13 and a quotation step $14. The order receiving step S11 is that after a customer end 6 has input the inquiry information, a work order module 1 receives the inquiry information and creates a work order form which is sent to a transportation matching module 2.

The transportation matching step S12 is that after the order receiving step S11 is completed, the work order form is sent to the transportation matching module 2. The transportation matching module 2 is connected to a transportation database 7. The transportation matching module 2 matches multiple transportation modes with the work order form. The multiple transportation modes are sent to a calculation module 3.

The calculation step S13 is that after the transportation matching step S12 is completed, the calculation module 3 calculates an operation amount required by each of the multiple transportation modes that match the work order form.

The quotation step S14 is that after the calculation step S13 is completed, a quotation module 4 receives and integrates the operation amounts from the calculation module 3 and sends a quotation information to the customer end 6.

Furthermore, the calculation module 3 of the calculation step $13 further includes a time estimating section 32. The time estimating section 32 calculates an estimated processing time of each of the multiple transportation modes.

The calculation module 3 of the calculation step S13 further includes a price comparison section 33. The price comparison section 33 compares operation amounts and estimated processing times matched with the multiple transportation modes. The price comparison section 33 calculates and provides multiple options in sequence that meets needs of the customer end 6.

As shown in FIGS. 1 to 3, the method further comprises a recording step S15 which includes a recording section in the logistics quotation system applied to operation end. After the quotation step S14 is completed, the recording section records and stores data input, modification and change of the customer end 6 before and after the quotation information is sent.

In practice, when the operation end receives the inquiry information from the customer end 6, the system creates the work order form and matches all of the transportation modes that are matched with the needs of the customer end 6. The system then calculates the operation amounts and sends a quotation information to the customer end 6, and asks the customer end 6 to confirm the quotation.

While we have shown and described the embodiment in accordance with the present invention, it should be clear to those skilled in the art that further embodiments may be made without departing from the scope of the present invention.

What is claimed is:

1. A logistics quotation system applied to operation end, comprising:
a work order module, a transportation matching module, a calculation module, and a quotation module connected with each other, the work order module connected to a customer end and including an order receiving section and a writing section which is connected to the order receiving section, the order receiving second receiving an inquiry information from the customer end and sending the inquiry information to the writing second, the writing section creating the inquiry information into a work order form;
the transportation matching module connected with a transportation database, the transportation matching module including a reading section and a matching section which is connected to reading section, the reading section reading an information from the transportation database and the work order form, and the matching section matching multiple transportation modes that match the work order form;
the calculation module including a calculation section, the calculation section calculating an operation amount required by each of the multiple transportation modes that match the work order form, and
the quotation module connected with the customer end, the quotation module receiving and integrating the operation amount from the calculation module and sending a quotation information to the customer end.

2. The logistics quotation system applied to operation end as claimed in claim 1, wherein the calculation module further includes a time estimating section, the time estimating section calculates an estimated processing time of each of the multiple transportation modes.

3. The logistics quotation system applied to operation end as claimed in claim 1, wherein the calculation module further includes a price comparison section, the price comparison section compares operation amounts and estimates processing times matched with the multiple transportation modes, the price comparison section calculates and provides multiple options in sequence that meets needs of the customer end.

4. The logistics quotation system applied to operation end as claimed in claim 1 further comprising a recording module, the recording module including a track section and a storage section connected to the track section, the track section recording information of data input, modification and change of the customer end before and after the quotation information is sent, the storage section storing the information recorded by the track section.

5. A method for operating logistics quotation system applied to operation end, comprising:
an order receiving step, a transportation matching step, a calculation step and a quotation step, wherein:
the order receiving step is that after a customer end has input the inquiry information, a work order module receives the inquiry information and creates a work order form;
the transportation matching step is that after the order receiving step is completed, the work order form is sent to a transportation matching module, the transportation matching module is connected to a transportation database, the transportation matching module matches multiple transportation modes with the work order form, the multiple transportation modes are sent to the calculation module;
the calculation step is that after the transportation matching step is completed, the calculation module calculates an operation amount required by each of the multiple transportation modes that match the work order form, and
the quotation step is that after the calculation step is completed, a quotation module receives and integrates the operation amounts from the calculation module and sends a quotation information to the customer end.

6. The method as claimed in claim 5, wherein the calculation module of the calculation step further includes a time estimating section, the time estimating section calculates an estimated processing time of each of the multiple transportation modes.

7. The method as claimed in claim 5, wherein the calculation module of the calculation step further includes a price comparison section, the price comparison section compares operation amounts and estimated processing times matched with the multiple transportation modes, the price comparison section calculates and provides multiple options in sequence that meets needs of the customer end.

8. The method as claimed in claim 5 further comprising a recording step which includes a recording section in the logistics quotation system applied to operation end, after the quotation step is completed, the recording section records and stores data input, modification and change of the customer end before and after the quotation information is sent.
